(19) United States
(12) Patent Application Publication
(10) Pub. No.: US 2016/0095770 A1
(43) Pub. Date: Apr. 7, 2016

(54) Rise Assist Device

(71) Applicant: Vadim Gordin, Mineola, NY (US)

(72) Inventor: Vadim Gordin, Mineola, NY (US)

(21) Appl. No.: 14/506,678

(22) Filed: Oct. 5, 2014

(51) Int. Cl. A61G 5/14; A47C 7/50; A47C 1/02

(52) U.S. Cl. CPC A61G 5/14; A47C 1/02; A47C 7/50

(57) ABSTRACT

Devices are disclosed herein which enable a user to rise from a seated position with minimal exertion.

### BACKGROUND

### Field

Many people who have compromised function in their lower backs, knee, or hips experience difficulty or pain when rising from a seated position out of a recliner, arm chair or couch. Consequently, devices are described herein which provide assistance and minimize the effort required to rise from a seated position or sit down from a standing position.

### SUMMARY

According to certain embodiments of the present disclosure, a rise assist device includes, a substantially planar portion of material sized and shaped as a rest for an occupant's feet thereby defining a foot rest, two tubular grips disposed near lateral ends of and extending dorsally from the foot rest, wherein a portion of the dorsal ends of the grips are inclined medially at an angle between 1₅ and ₄₅ degrees from normal such that when grasped the induce a moderate pronation of the hands of a user.

According to further embodiments of the present disclosure, the grips are braced against posterior translation by complementary tubular members coupled to the grips near the foot rest and extending in a posterior direction therefrom in a plane distinct from that of the foot rest.

According to further embodiments of the present disclosure, the bracing is substantially high to allow the user to execute a “dip” exercise against the bracing material when rising from a seated position.

According to further embodiments of the present disclosure, the bracing is disposed low enough to not obscure the actuation lever of a reclining chair.

According to further embodiments of the present disclosure, there is a substantially planar portion material extending in a posterior direction from the foot rest and coupled to the posterior portion of the bracing material thereby defining a support.

According to further embodiments of the present disclosure, the joint between the support and the foot rest is a joggle.

According to further embodiments of the present disclosure, the foot rest has a portion of bracing material disposed upon the posterior edge thereof, wherein the bracing material is sized and shaped to provide flexural rigidity while still allowing the foot-rest of a recliner to travel above the bend unimpeded.

According to further embodiments of the present disclosure, the bracing material is chosen from one of a dorsal-facing bend, a portion of tubing coupled to the foot, a portion of solid material coupled to the foot rest.

According to further embodiments of the present disclosure, the handles are joined to the foot rest by means of one of, star nuts, floor flanges, or welds.

According to further embodiments of the present disclosure, the handles are adjustable in height by means of a locking telescoping mechanism.

### BRIEF DESCRIPTION OF THE FIGURES

In the figures, which are not necessarily drawn to scale, like numerals describe substantially similar components throughout the several views. The drawings illustrate generally, by way of example, but not by way of limitation, various embodiments discussed in the claims of the present document.

FIG. 1 shows a top isometric view of a Rise Assist Device placed near a reclining chair.

FIG. 2 shows a rear isometric view of a Rise Assist Device.

FIG. 3 shows a front isometric detail view of the joint between a foot plate and support brace.

FIG. 4 shows isometric and detail views of a foot plate.

FIG. 5 shows a support brace.

FIG. 6 shows a tubing star nut.

### DETAILED DESCRIPTION OF THE FIGURES

Various embodiments of the presently disclosed apparatus will now be described in detail with reference to the drawings, wherein like reference numerals identify similar or identical elements. In the drawings and in the description that follows, anatomical terms of reference such as dorsal, lateral, anterior, and sagittal shall have their accepted meanings in the arts.

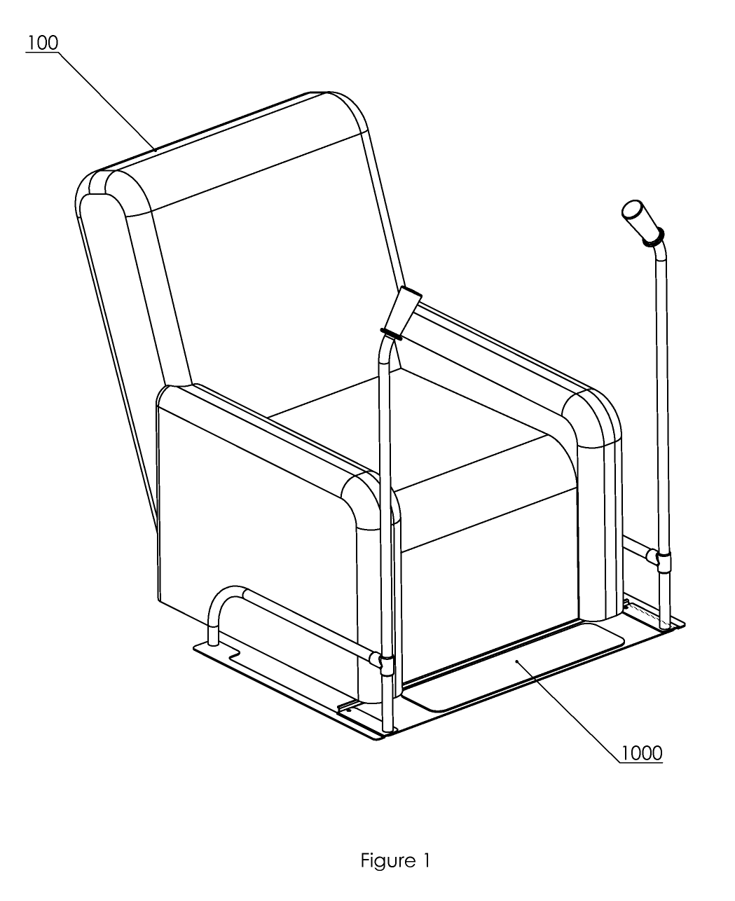

According to a first embodiment of the present disclosure, shown in FIG. 1, a Rise Assist Device woo is a substantially rigid armature sized and shaped for helping an occupant to lower themselves down into or to rise up out of a seat, including for instance a recliner 100 as shown in FIG. 1. The shape of the embodiment of the disclosure shown in the figures is such that the footrest of a recliner is able to be deployed without being impeded in any way by the structure of the Rise Assist Device woo.

Although Rise Assist Device woo is shown in the figures as being used with a reclining chair, it is capable of being used successfully with a commode, couch, or bed as well.

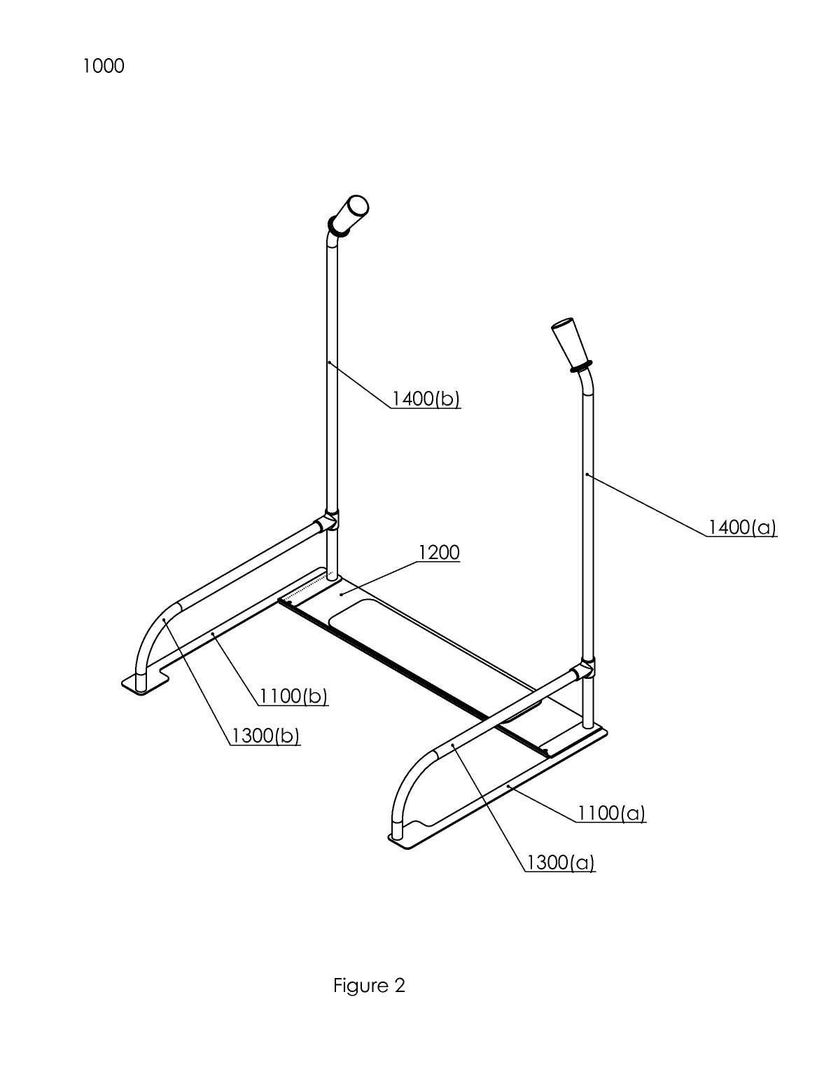

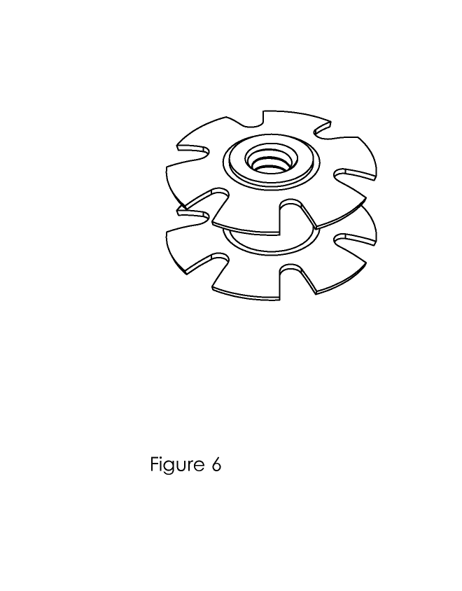

Referring now to FIG. 2, a Rise Assist Device woo includes at least a foot plate 1200, mirrored and opposing support braces 100(a and b), handles 1400(a and b) extending dorsally from foot plate 1200, and support tubes 1300(a and b) connecting the ventral end portion of handles 1400(a and b) to the respective posterior end portions of braces 1100 (a and b). Handles 1400(a and b) are elongated portions of tubing, composed of a rigid material including for instance steel or aluminum, which have a medial-facing bend in the range between 15 and 45 degrees from the long axis of the remainder of the tube, at the dorsal end portion thereof. The bend at the dorsal end portion of handles 1400(a and b) is sized and shaped to pronate the hands of the user when he grasps them, thereby allowing the user to more powerfully engage their shoulders, biceps, and chest when using the handles to assist when rising from a seated position. Handles 1400(a and b) are fixed to the foot plate 1200 at the ventral ends thereof by means of a threaded screw extending dorsally into the tube where it is fixed to a star nut including for instance that which is shown in FIG. 6.

Support tubes 1300(a and b) are elongated portions of tubing, composed of a rigid material including for instance steel or aluminum, sized and shaped so that they can be rigidly fixed to both the respective vertical portion of handles 1400(A and B) and the respective posterior end portions of support braces 1100(a and b), thereby providing rigidity against posterior force applied to the handles 1400(a and b) by a user. Although the support tubes are shown in the figures as running substantially parallel to the foot plate 1200, there are further embodiments of the present disclosure where they are straight portions of tube extending in a posterior and ventral direction from the handles 1400 to a fixed point, thereby defining a triangle.

Support tubes 1300(a and b) are coupled to respective handles 1400(A and b) by means of a “T” tubing connector as shown in FIGS. 1 and 2 which clamps the two portions of tube together by means of a captive nut and screw. It will be apparent to on having ordinary skill in the mechanical arts the that rigid connection between support tubes 1300(a and b) and handles 1400(a and b) can be achieved by means of another coupling means including for instance a butt joint, a weld, a screw extending into support tube 1300(a or b) through handle 1400(a or b) and a star nut or similar structure disposed within support tube 1300(a or b).

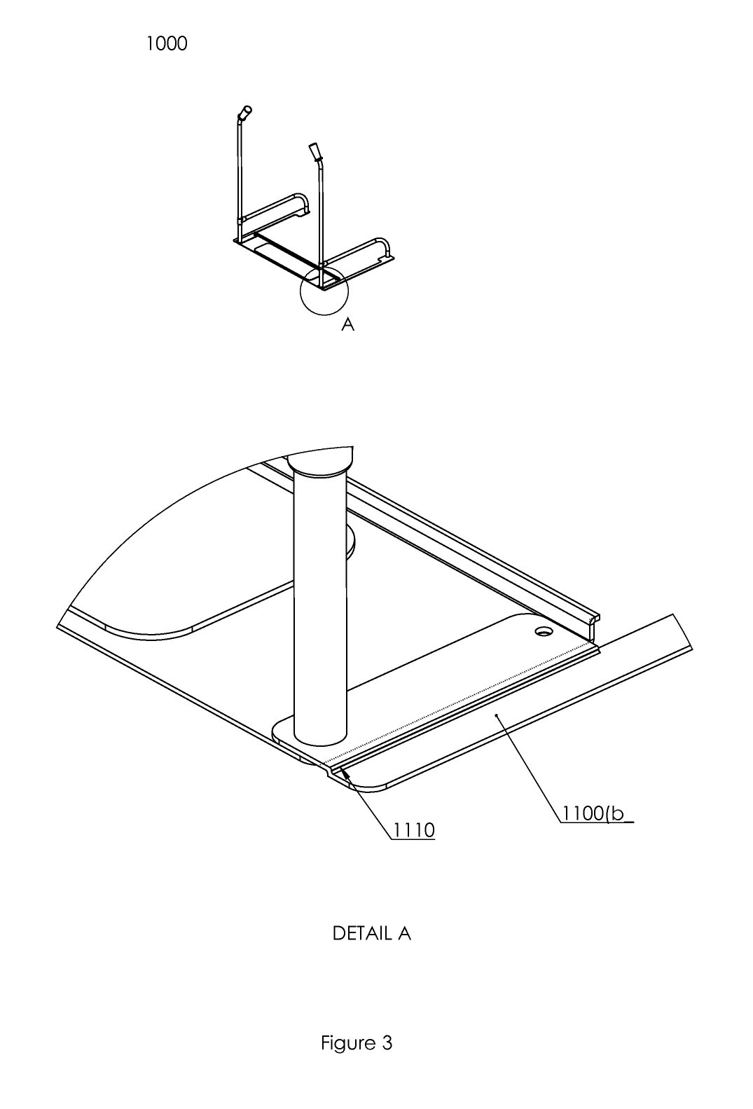

Referring now to FIG. 3, a detail view of the joint between a foot plate 1200 and a support brace 1100(a or b) is shown. Such a seam is commonly referred to as a “joggle” or alternatively a “countersunk lap seam” in the sheet metal fabrication arts. The seam serves two functions. First, is allows the medial portion of support brace 1100(a or b) to lay flat on upon the ventral face of foot plate 1200 while the lateral portion of support brace 1100(a or b) rests flat upon the same surface as the ventral face of foot plate 1100. Second, the seam adds additional flexural rigidity to the assembly. The support brace 1100(a or b) is fixed to foot plate 1200 as well as handle 1400(a or b) by means of a nut and bolt extending through the shown apertures disposed therein.

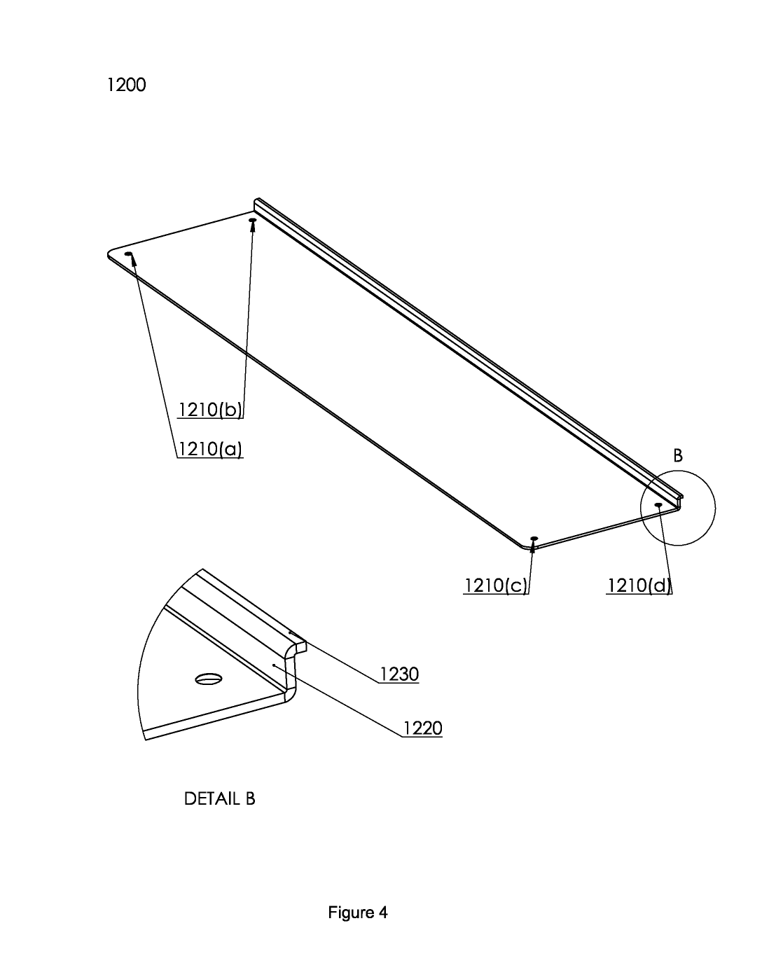

Referring now to FIG. 4, a foot plate 1200 is shown. Foot plate 1200 is a substantially planar member having four apertures 1210(a-d) disposed near the corners thereof as well as a plurality of bends 1220 and 1230 disposed near the posterior edge thereof. Bends 1220 and 1230 serve to create flexural rigidity for the device, while apertures 1210(a and c) are sized and shaped to couple the foot plate 1200 to support braces 1100(a and b) respectively as well as handles 1400(a and b). Apertures 1210(b and d) are sized and shaped to couple the foot plate 1200 to support braces 1100(a and b) respectively. The coupling may be achieved by means of bolts, pressed fasteners such as riv-nuts, pem-studs, or alternatively rivets.

Foot plate 1200 is comprised of a substantially rigid material including for instance 11 gauge steel or aluminum sheet. Although the flexural rigidity of foot plate 1200 is achieved in the appended figures by means of a bend, there are further embodiments of the present disclosure wherein a portion of round or rectangular stock (either hollow or solid) is coupled to the posterior portion of the foot plate by means of a weld, bolt, rivet, or other coupling means known in the mechanical arts.

As shown in FIGS. 1 and 2, there is a gripping surface comprised of for instance crystalline abrasive self-adhesive tape disposed upon the ventral surface of foot plate 1200. The gripping surface may be a large integral gripping surface as shown in the figures or alternatively by a pattern of gripping surfaces such as strips, dots, or stars of gripping material disposed upon the surface. According to certain embodiments of the present disclosure intended for use on slippery surfaces such as tile or hardwood floors, there is a gripping surface disposed upon the ventral face of foot plate 1200.

The ventral gripping surface may be comprised of a portion of self-adhesive rubber or a gripping foam such as EVA applied as an integral piece or as a pattern as described above.

Alternatively to a applied grip on one or both of ventral and dorsal faces, the “gripping” behavior may be achieved by means of a textured finish including for instance a instance a hammer or crinkle finish powder coat, Plasti-Dip, or a vinyl coating.

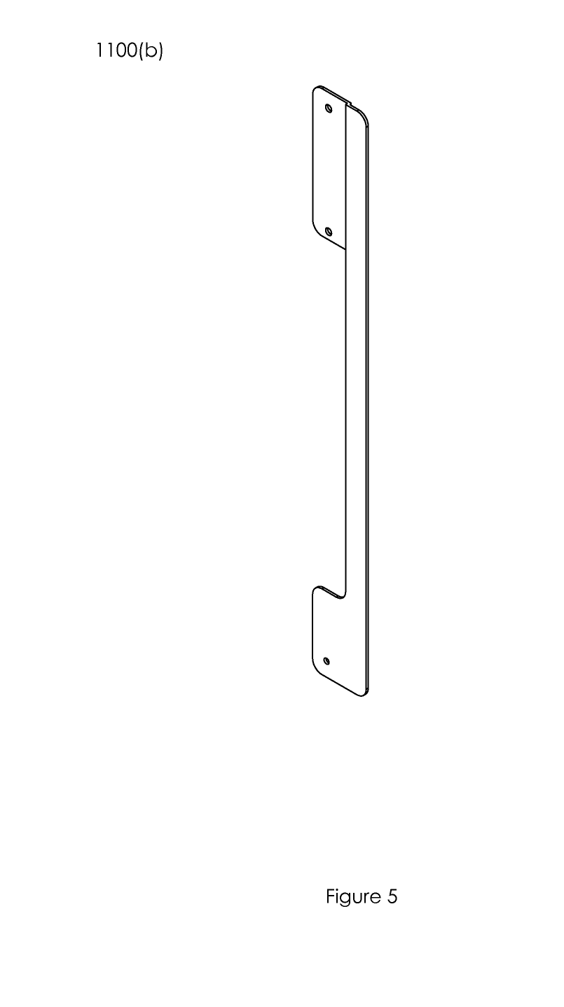

Referring now to FIG. 5, an isometric view of a support brace 1100(b) is shown. Support brace 1100(b) is a substantially chiral reflection of support brace 1100(a). Support braces 1100(a and b) are substantially planar members having a an aperture disposed upon the posterior end thereof sized and shaped to couple the support brace to one of support tubes 1300(a or b) and two apertures a the anterior end portion thereof near the joggle sized and shaped to couple the support brace to a foot plate 1200 as well as one of handle 1400(a or b).

One of the major purposes of support brace 1100(a and b) is to prevent posterior translation of the posterior end portion of support tube 1300 when a user applied force to the grips disposed at the dorsal ends of handles 1400(a and b). This same purpose may also be achieved by a portion of tubing which runs parallel to support tube 1300 (a or b) and is coupled to both the vertical handle 1400 (a or b) and the support tube 1300(a or b) by means of a weld, bracket, or other coupling means known in the mechanical arts.

Referring now to FIG. 6, an example of a star nut is shown. It will be apparent to one having ordinary skill in the mechanical arts that the coupling function between tube and plate components achieved by a star nut in the preceding specification could also be achieved by a floor flange, a weld, or other mechanical coupling device known in the mechanical arts.

A method of using Rise Assist Device woo will now be described. Initially, a

Rise Assist Device is placed in front of a recliner as shown in FIG. 1. Next a user approaches the assembly and backs into the seat with their feet disposed upon the center of foot plate 1200, their posterior directed towards the rear of the seat, and their left and right hands grasped upon the grips at the dorsal ends of handles 1400(a and b). Next, the user lowers their hips into the seat while bracing the hands upon the grips, thereby reducing the amount of exertion or strain upon their knees, hips, and lower back.

Next, when a user wishes to rise from a seated position, they reverse the previously described process. The user places their feet upon the medial portion of foot plate 1200 and grasps the grips with their hands. Finally, they raise themselves up to a standing position by pulling on the handles simultaneously with extending their feet, thereby rising to a standing position.

Although the invention has been described in the preceding text with reference to specific structures, these are provided as but one illustrative and non-limiting method of implementing the appended claims.

What is claimed is:

1. A rise assist device comprising,
a substantially planar portion of material sized and shaped as a rest for an occupant's feet thereby defining a foot plate, two tubular grips disposed near lateral ends of and extending dorsally from the plate, wherein a portion of the dorsal ends of the grips are inclined medially at an angle between 15 and 45 degrees from normal such that when grasped the induce a moderate pronation of the hands of a user.

2. The rise assist device of claim 1, wherein the grips are braced against posterior translation by complementary tubular members coupled to the grips near the foot rest and extending in a posterior direction therefrom in a plane distinct from that of the foot plate.

3. The rise assist device of claim 2, wherein the bracing is substantially high to allow the user to execute a “dip-like” exercise against the bracing material when rising from a seated position.

4. The rise assist device of claim 2, wherein the bracing is substantially low enough to not obscure the actuation lever of a reclining chair.

5. The rise assist device of claim 2, wherein there is a substantially planar portion material extending in a posterior direction from the foot plate and coupled to the posterior portion of the bracing material thereby defining a support.

6. The rise assist device of claim 5, wherein the joint between the support and the foot plate is a joggle.

7. The rise assist device of claim 1, wherein the foot plate has a portion of bracing material disposed near the posterior edge thereof, wherein the bracing material is sized and shaped to provide flexural rigidity while still allowing the foot-rest of a recliner to travel above the bend unimpeded.

8. The rise assist device of claim 7, wherein the bracing material is chosen from one of a dorsal-facing bend, a portion of tubing coupled to the foot, a portion of solid material coupled to the foot rest.

9. The rise assist device of claim 1, wherein the handles are joined to the foot plate by means of one of, star nuts, floor flanges, or welds.

10. The rise assist device of claim 1, wherein the handles are adjustable in height by means of a locking telescoping mechanism.

11. A rise assist device comprising,
a substantially planar portion of material sized and shaped as a rest for an occupant's feet thereby defining a foot rest, two tubular grips disposed near lateral ends of and extending dorsally from the plate, wherein a portion of the dorsal ends of the grips are inclined medially at an angle between 15 and 45 degrees from normal such that when grasped the induce a moderate pronation of the hands of a user, wherein the grips are braced against posterior translation by complementary tubular members coupled to the grips near the foot rest and extending in a posterior direction therefrom in a plane distinct from that of the foot rest.

12. A rise assist device comprising, a substantially planar portion of material sized and shaped as a rest for an occupant's feet thereby defining a foot rest, two tubular grips disposed near lateral ends of and extending dorsally from the plate, wherein a portion of the dorsal ends of the grips are inclined medially at an angle between 15 and 45 degrees from normal such that when grasped the induce a moderate pronation of the hands of a user, wherein the grips are braced against posterior translation by complementary tubular members coupled to the grips near the foot rest and extending in a posterior direction therefrom in a plane distinct from that of the foot rest, wherein there is a substantially planar portion material extending in a posterior direction from the foot rest and coupled to the posterior portion of the bracing material thereby defining a support.
